(19) United States
(12) Patent Application Publication
(10) Pub. No.: US 2005/0012459 A1
(43) Pub. Date: Jan. 20, 2005

(54) Printed self illuminating color pixel circuit

(76) Inventor: Patrick Thomas Padilla, Tamarac, FL (US)

Correspondence Address: Patrick Thomas Padilla, 7805 N.W. 73 AVE, Tamarac, FL, 33321, US

(21) Appl. No.: 10/621,261

(22) Filed: Jul. 16, 2003

(51) Int. Cl. H01J 25/10

(52) U.S. Cl. 315/5.48

(57) ABSTRACT

Printed self illuminating color pixel circuit is printed micro wiring forming a circuit that in essence lights up and turns off to form different forms of display especially “High Definition Television” screens. Making printed screens affordable to the world population.

### BACKGROUND OF INVENTION

Printed micro wiring is the basis for a printed self illuminating color pixel circuit making a printed circuit that lights on and off in three different colors.

### SUMMARY OF INVENTION

Printed self illuminating color pixel circuit is a printed micro wiring into a circuit that Lights up and turns off in a millisecond. When printed in the order of pixels of a “High Definition Television” screen it replaces the screen with only true flat screen and making “High Definition Television” and other forms of “Display Monitors LCD's” available to the masses at a fraction of the cost.

### BRIEF DISCRIPTION OF DRAWINGS

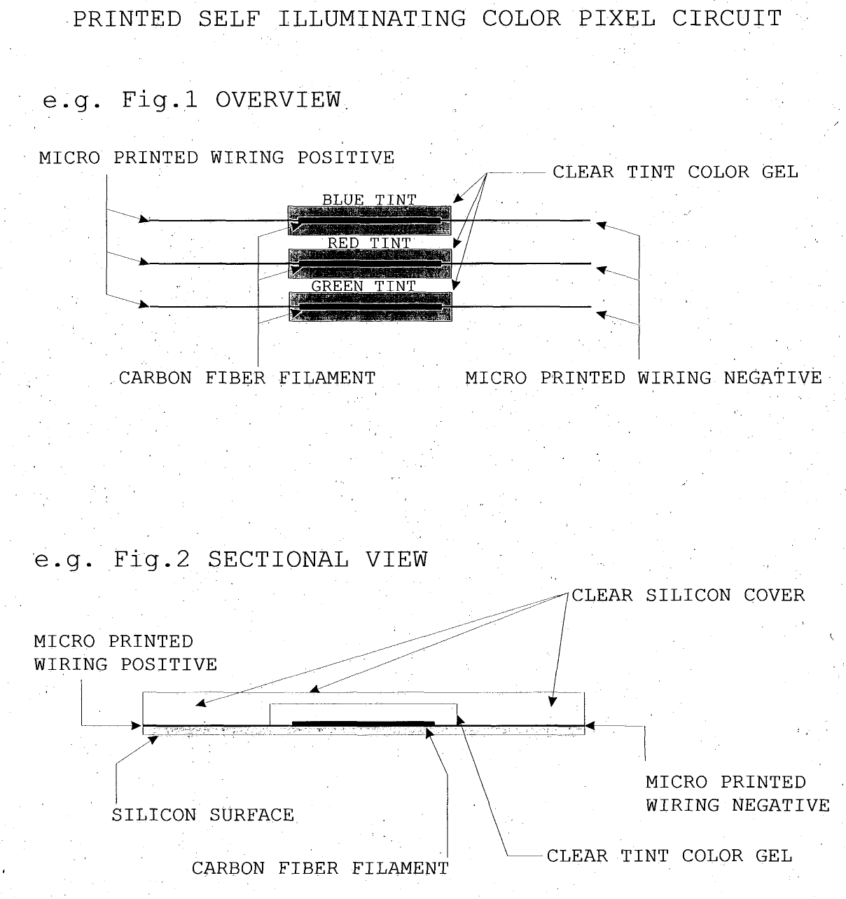

e.g. FIG. 1 overview looking down on a single printed self illuminating color pixel circuit.

e.g. FIG. 2 sectional view showing layers of micro printed wiring showing printed self illuminating color pixel circuit.

### DETAILED DESCRIPTION

Printed self illuminating color pixel circuit is printed micro wiring on a silicone surface with three separate positive and three separate negative ports, opposite of each other and a connecting bridge of a high carbon fiber filament then each connection is covered over by a clear colored gel printed in one each color red, blue and green and covered completely by a clear silicone coat. The micro wiring connecting each pixel can be from the underside of the silicone surface or on the top by a printed matrix or a combination of both.

1. Printed self illuminating color pixel circuit is printed micro wiring made into a circuit. This printed circuit is in essence a printed “High Definition Television” screen. The firing mechanisms replacing ions cannons have already been established as well as the high carbon filament ink. Printing pixels in this form either on a hard or flexible surface such as plastic or paper will make most forms of displays especially “High Definition Television so inexpensive making televisions available for the total population anywhere in the world.
